(19) United States
(12) Patent Application Publication
(10) Pub. No.: US 2006/0245824 A1
(43) Pub. Date: Nov. 2, 2006

(54) Fastening arrangement for connecting tubes which intersect or adjoin each other in a T-shape, and tubular frames with tubes connected in such a way

(76) Inventor: Alfred Bilsing, Attendorn (DE)

Correspondence Address: STITES & HARBISON PLLC, 1199 NORTH FAIRFAX STREET, SUITE 900, ALEXANDRIA, VA, 22314, US

(21) Appl. No.: 11/394,191

(22) Filed: Mar. 31, 2006

(30) Foreign Application Priority Data
Apr. 4, 2005 (DE) 10 2005 015 415.8

(51) Int. Cl. F16B 7/04

(52) U.S. Cl. 403/400

(57) ABSTRACT

The invention is used to connect round or octagonal tubes conducted past each other in an intersecting manner by means of at least one screw, in particular in connection with support frames equipped with vacuum grippers for transporting and holding sheet metal parts in the automobile industry. In each one of the two tubes an insert is arranged at the joint, which matches their respective inner cross section and partially fills it, one of the inserts constitutes an underlay for the head of the screw extending through aligned transverse bores in the tubes, and whose other insert forms a support for the screw shank. An intermediate element matched to the outer circumferential surfaces of the two tubes is clamped between the two tubes.

The invention relates to a fastening arrangement for connecting round or octagonal tubes, which are conducted past each other in an intersecting manner, and a fastening arrangement for connecting tubes in a T-shape, by means of at least one screw, in particular in connection with support frames equipped with vacuum grippers for transporting and holding sheet metal parts in the automobile industry.

It should be noted that in this field the support frames for the vacuum grippers become more complex and heavier, for example with more than twenty clamping locations they weigh more than 400 kg. A comparatively large portion of the weight is due to the conventional clamping elements which enclose the tubes from the outside.

It is the object of the invention to replace these comparatively heavy clamping elements with lighter fastening arrangements, by means of which support frames which are just as stable can be created.

In connection with frames with round or octagonal tubes, which are conducted past each other in an intersecting manner, the above object is attained in accordance with the invention in that at the joint an insert is arranged in each one of the two tubes, which matches their respective inner cross section and partially fills it, one of the inserts constitutes an underlay for the head of the screw extending through aligned transverse bores in the tubes, and whose other insert forms a support for the screw shank, and that an intermediate element matched to the outer circumferential surfaces of the two tubes is clamped between the two tubes.

In accordance with the invention, in connection with frames with tubes intersecting each other in a T-shape, of which the first tube, which continues through the joint, is a round or octagonal tube, an insert is arranged in the first tube, which fits its interior diameter and partially fills it and constitutes an underlay for the head of the screw extending through a transverse bore in the first tube, and whose shank can be screwed into a counterpiece fixed in the second tube terminating at the joint, wherein the adjoining end of the second tube is chamfered to match the circumferential surface of the first tube.

The invention offers the advantage that the parts required for connecting the tubes can be smaller and lighter than the clamping elements used up to now. Very stiff tube connections can be produced in spite of this, because the forces generated when the screws are tightened act as pressure forces on the remaining portions of the fastening arrangement and the tubes, so that these parts have a great load-bearing capacity.

Some exemplary embodiments of the invention will be explained in greater detail by means of the drawings in what follows.

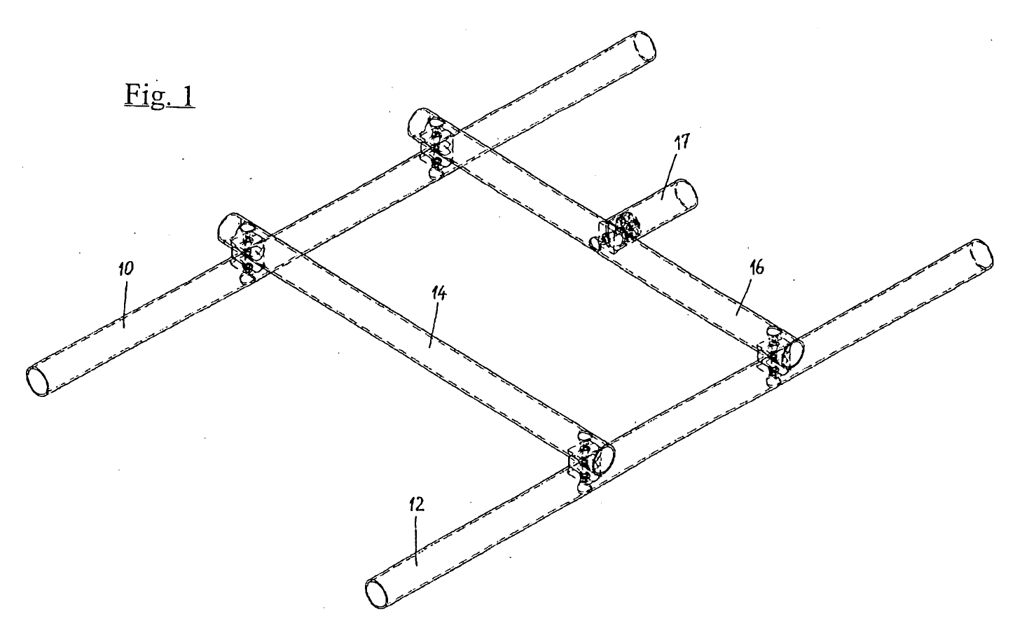

FIG. 1 is a perspective plan view of a support frame consisting of interconnected round tubes, to which the vacuum grippers for picking up and transporting sheet metal parts are to be attached,

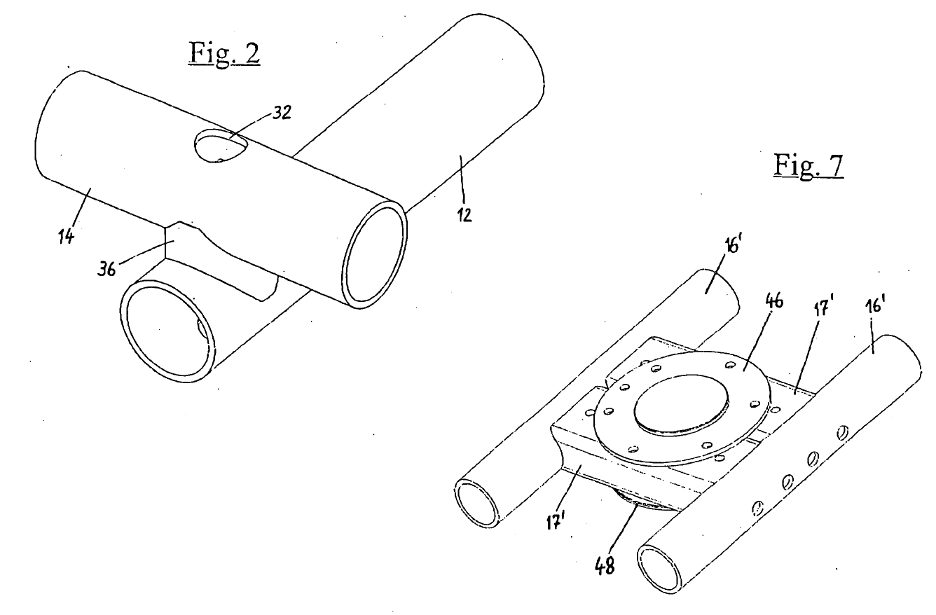

FIG. 2 is a perspective plan view in a larger scale of an intersection point between two tubes of the frame in accordance with FIG. 1,

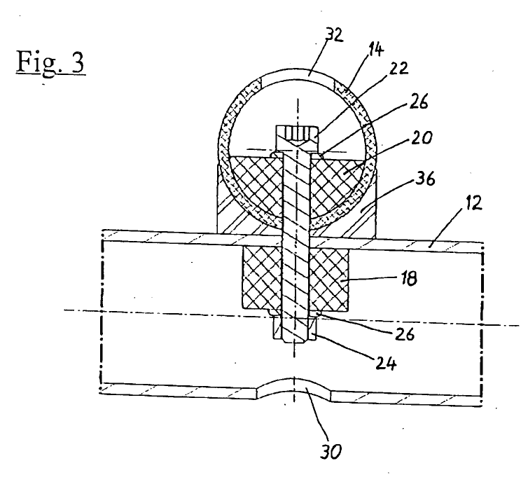

FIG. 3 is a cross section through the upper of the two tubes represented in FIG. 1 at the intersection,

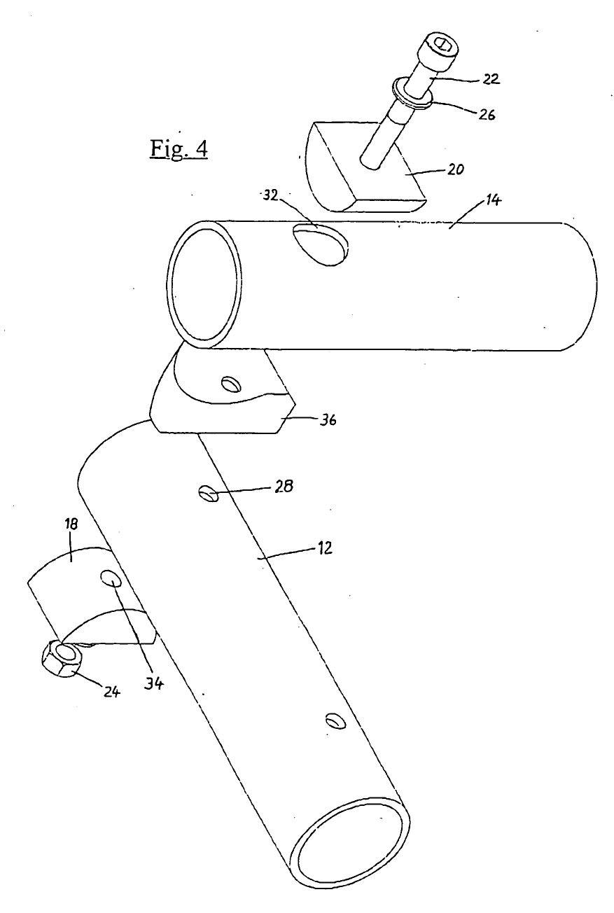

FIG. 4 is an exploded view of the parts connected with each other at an intersection point in accordance with FIGS. 2 and 3,

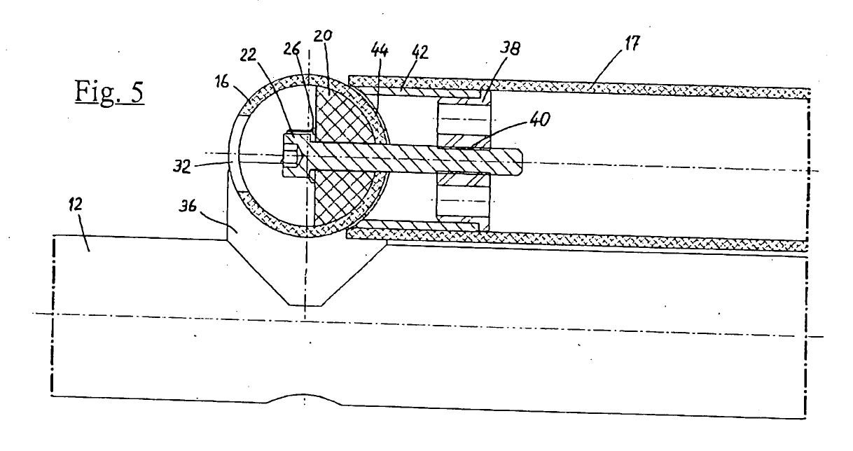

FIG. 5 is a cross section through that tube connection of the support frame in accordance with FIG. 1 at which a tube with its end adjoins a continuous tube in a T-shape,

FIG. 6 is an exploded view of the parts connected with each other at the tube connection in accordance with FIG. 5,

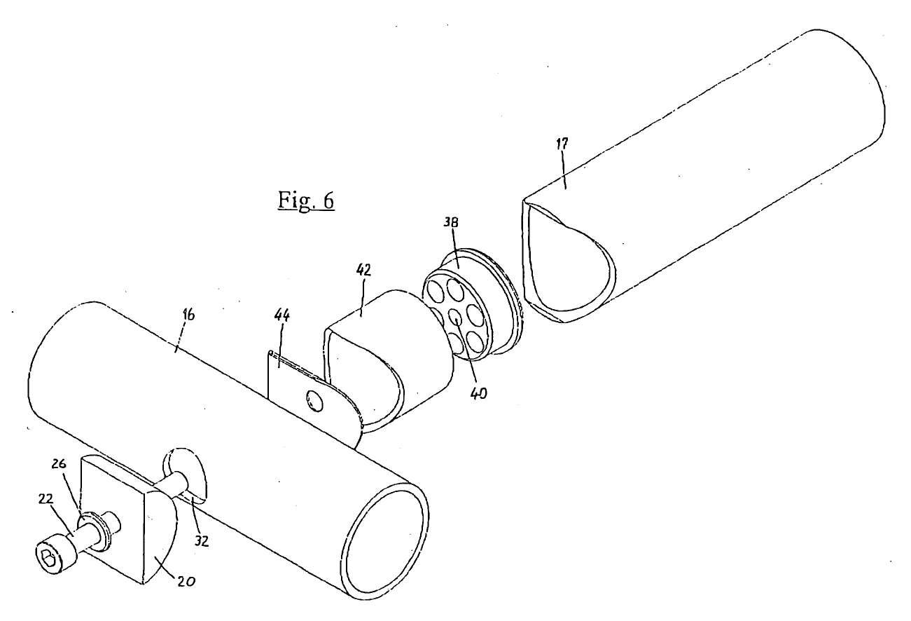

FIG. 7 is a perspective plan view of a tube connection similar to FIGS. 6 and 7, however, with rectangular tubes adjoining round tubes,

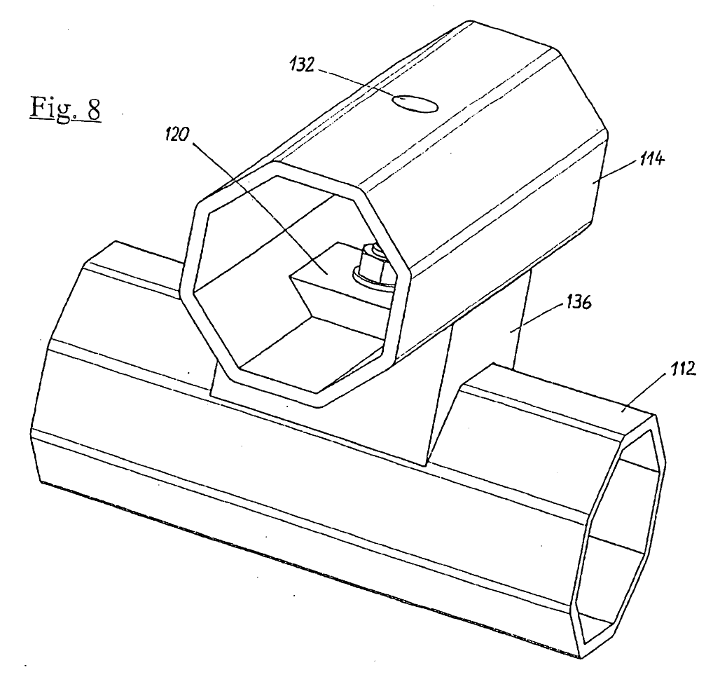

FIG. 8 is a perspective plan view corresponding to FIG. 2 of an intersection between two octagonal tubes of a frame in accordance with FIG. 1, produced from such tubes,

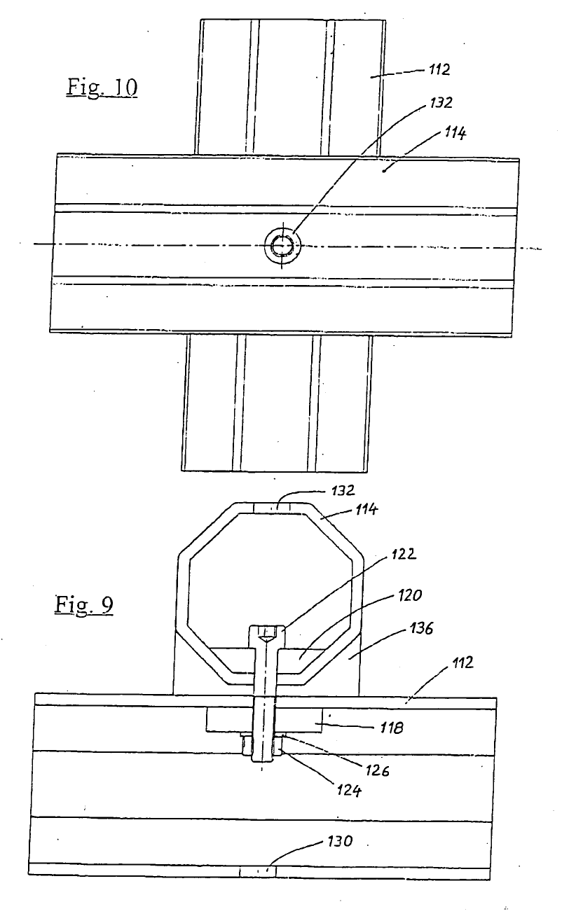

FIG. 9 is a cross section corresponding to FIG. 3 through the intersection of the tubes in accordance with FIG. 8,

FIG. 10 is a view from above on the intersection of the tubes in accordance with FIGS. 8 and 9,

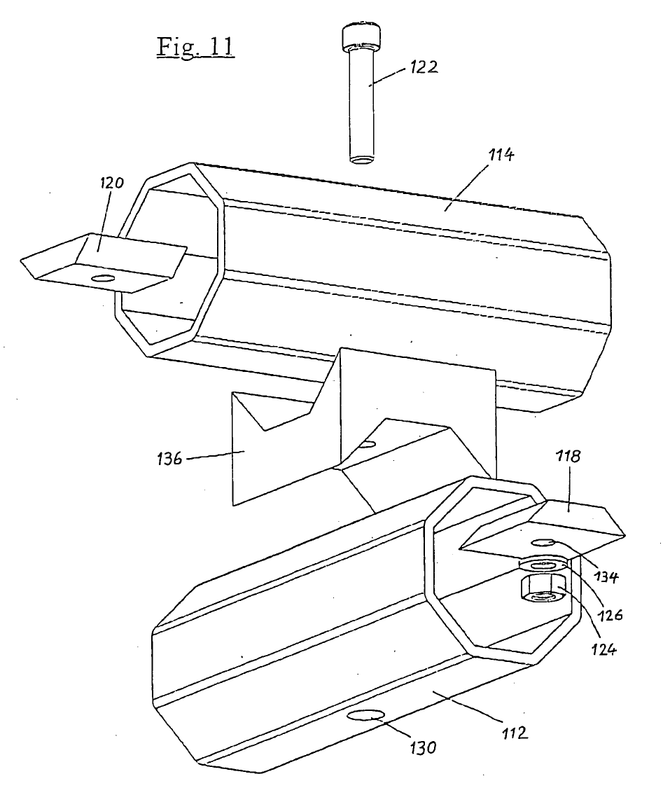

FIG. 11 is an exploded view corresponding to FIG. 4 of the elements connected with each other at the intersection in accordance with FIGS. 8 and 9,

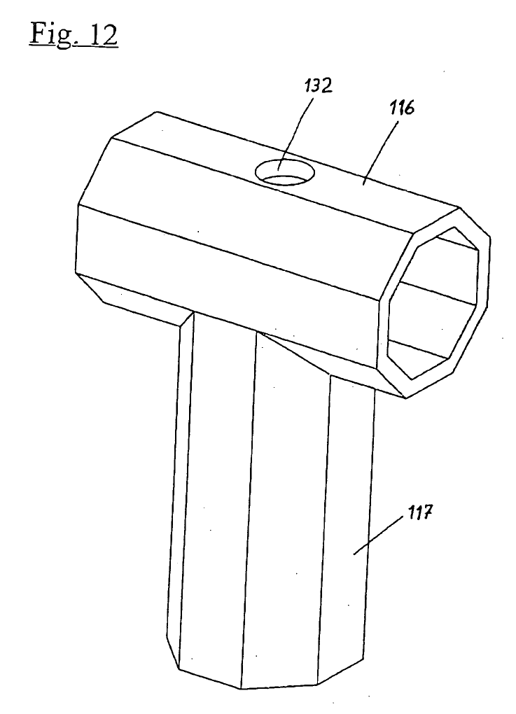

FIG. 12 is a perspective representation of that tube connection of a support frame corresponding to FIG. 1 but consisting of octagonal tubes, in which a tube with its end adjoins a continuous tube in a T-shape,

FIG. 13 is a view from above on the tube connection in accordance with FIG. 12,

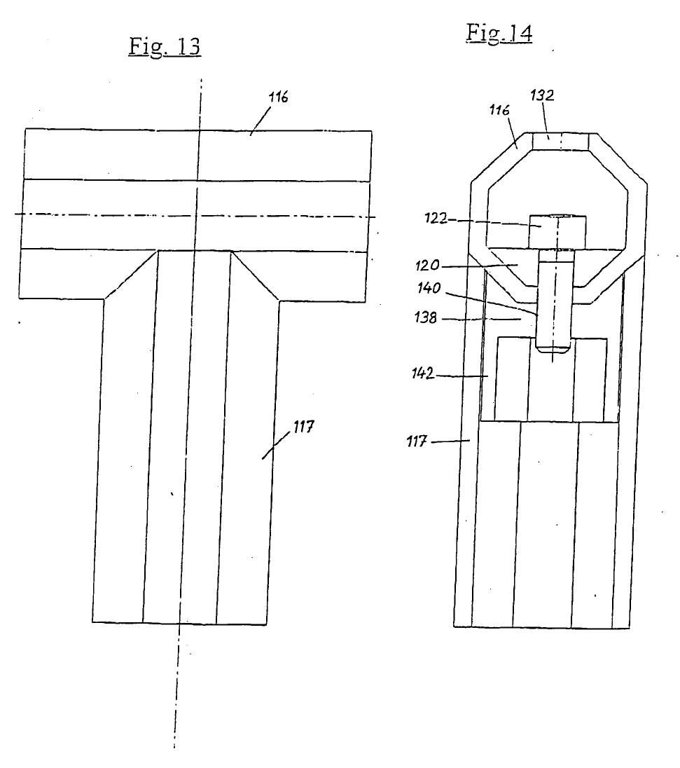

FIG. 14 shows a cross section corresponding to FIG. 5 of the tube connection in accordance with FIGS. 12 and 13, and

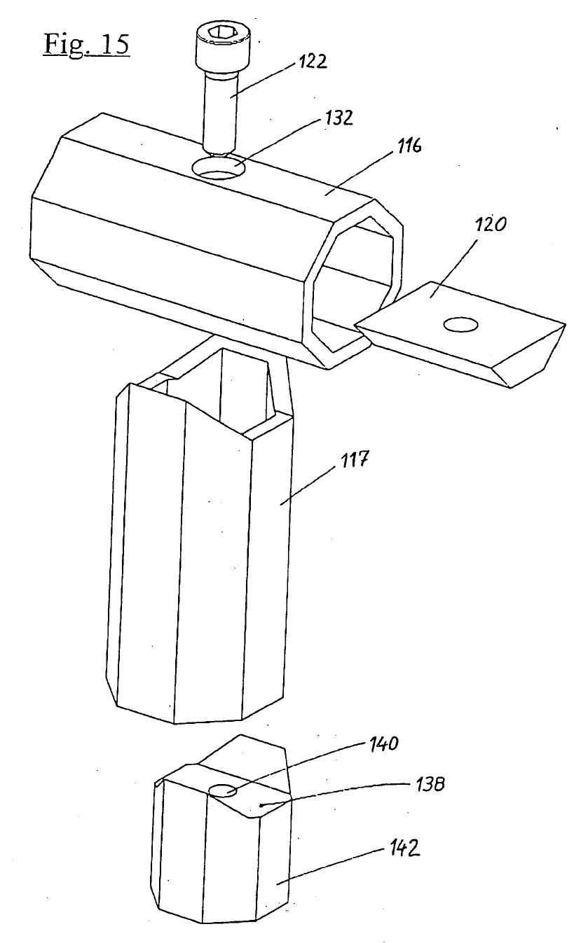

FIG. 15 is an exploded view of the parts which are connected with each other at the tube connection in accordance with FIGS. 12 to 14.

In the example, the support frame represented in FIG. 1 consists of two parallel round longitudinal tubes 10, 12, which are fixedly connected with round tubes 14, 16 placed intersectingly above them. The fastening arrangement at the intersections of the said tubes will be explained in greater detail in what follows by means of FIGS. 2, 3 and 4.

As can be best seen in FIGS. 3 and 4, a partially cylindrical insert 18 or 20 has been arranged in each one of the two involved tubes at each intersection. The radius of its cylindrical shell face respectively fits the interior diameter of the tube 12 or 14 in which the insert 18 or 20 is seated. Preferably the partially cylindrical insert 18 or 20 takes up not quite half the interior cross-sectional surface of the associated tube.

The inserts 18, 20 substantially have the function of washers, wherein on one of their sides they are matched to the cylindrical form of the interior wall of the tube 12 or 14. The same as a washer, the inserts 18, 20 also have a hole for passing a screw 22 through which, in the case of the example, connects the tubes 12, 14 at the intersection. Here, the partially cylindrical insert 20 in the tube 14 constitutes a washer for the head of the screw 22, while the partially cylindrical insert 18 in the tube 12 represents a washer for a nut 24 screwed to the end of the shank of the screw 22. It is possible to additionally insert a further washer 26 between the screw head and the insert 20, as well as between the nut 24 and the insert 18. In the mounted state in accordance with FIG. 3 the screw 22 extends through two transverse bores aligned with each other in the tubes 12, 14, of which the transverse bore in the tube 12 is shown in FIG. 4 and identified by 28.

A larger hole 30 or 32 is provided in the tubes 12, 13 in the diametrically oppositely located sides, each aligned with the transverse bore 28 through which the screw 22 extends in the mounted state. If the tube diameters are small in comparison to the length of the screw 22, the screw 22, for example, is introduced through the hole 32 in the tube 14 and is pushed through the hole in the insert 20, the transverse bores 28 and the hole in the insert 18, identified by 34 in FIG. 4. The nut 24 and the associated washer 26 can be pushed or screwed on the shank end of the screw 22 through the hole 30 in the tube 12.

If the screw 22 is screwed into the nut 24, normally the tube 14 would be pressed against the tube 12 only at two locations to the right and the left of the screw shank. In order to distribute the pressure force on each tube over a larger surface, an intermediate element 36 is provided, which on its side which faces up in respect to FIG. 3, has a depression matched to the exterior circumferential surface of the tube 14, and on its underside a depression matched to the exterior circumferential surface of the tube 12. The two groove-shaped depressions intersect in the same way as the tubes 12, 14. As can be seen in FIG. 3, the intermediate element 36 extends around the tube 14 over a circumferential angle—approximately half the circumference—which is almost of the same size as to which the insert 20 rests against the inside. The intermediate element 36 also extends around almost half of the other tube 12 in the same way.

The inserts 19 and 20, as well as the intermediate element 36, can consist of a hard plastic material or an aluminum alloy, for example. If the thread of the screw 22 is not screwed into a nut 24, but into a threaded bore in the insert 18, the latter should be made of metal, preferably steel. Regardless of the material of the inserts 18, 20, they would be glued into the respectively associated tube 12 or 14.

FIG. 3 clearly shows that it is possible to apply considerable clamping forces by means of the screw 22, because in this case all elements through which the screw shank extends merely rest against each other with their contact faces and are pressed together, i.e. they are only subjected to pressure forces. They therefore can be subjected to great forces.

The tubes 12, 14 are weakened at the intersections because of the transverse bores 28 and the holes 30 and 32. If this weakening becomes critical in view of the expected stress on them, there is always the option of increasing the wall thickness of the tubes 12, 14 at the intersection points in that tube sections are glued into the tubes or are glued onto the tubes at these locations.

It is of course necessary in this case to take the increased wall thickness into consideration when determining the radii of the inserts 18, 20 and of the intermediate element 36. The transverse bores 28 and the holes 30 and 32 then also extend through the glued-in or glued-on tube sections which, for example, can consist of an aluminum alloy or of a CFR (carbon fiber reinforced) plastic material, the same as the tubes.

The support frame shown in FIG. 1 also has a tube joint on the tube 16, at which a further round tube 26 with its end adjoins the continuous tube 16 in a T-shape. This joint will be explained in greater detail in what follows by means of FIGS. 5 and 6.

A comparison of FIG. 5 with FIG. 3 shows that the arrangement of an insert and a screw in the tube 16 is exactly the same as the one in accordance with FIG. 3 in the tube 14. Therefore the same reference numerals have been used in FIG. 5 to that extent for corresponding parts. The difference only starts outside of the tube 16.

In the fastening arrangement in accordance with FIG. 5, the screw inserted through the mounting hole 32 extends axially through a transverse bore in the tube 16, which corresponds to the transverse bore 28 in FIG. 4, into the end of the tube 17 adjoining the tube 16. In this case a counterpiece 38 in the form of a comparatively thick disk with a central threaded bore 40 fitting the screw 22, which has been inserted into the tube 17, is used for supporting the shank of the screw 22. The counterpiece 38 is glued into the end of the tube 17 together with a tube element 42 made of aluminum or CFR plastic. The front end of the tube 17 adjoining the tube 16 is chamfered out in the shape of a partial cylinder, for example by means of a cylindrical milling cutter, after the tube element 42 has been glued in. The radius of the chamfered-out groove corresponds to half the exterior diameter of the tube 16. By means of this it is achieved that the tube 17, which is reinforced at its end by the tube element 42, rests along the entire circumference of is chamfered-out front edge against the exterior circumference of the tube 16 and is pressed against it when the screw 22 is tightened.

In order to be able to apply an even larger clamping force it is possible to glue a shell 44, consisting of a tube section, into the partial-cylindrically chamfered-out end opening of the tube 17 which, to match the material of the tube 17 and the tube element 42, can be made of aluminum or CFR plastic. The partially cylindrical shell 44 terminates at the front edge of the tube 17. It is understood that in case a shell 44 is glued into the opening of the tube 17, the radius of the chamfered-out portion must be larger corresponding to the thickness of the shell 44 than in case of tube connections without such a shell 44. If needed, the latter can also be replaced by a tube section, which, for reinforcing it, is glued into or on to the tube 16 at the joint. However, gluing-in the shell 44 offers the advantage that it counteracts the spreading open of the opening of the tube 17 when the screw 22 is tightened.

A further embodiment option of the invention consists in that the partially cylindrical circumferential surfaces of the inserts 18, 20, and/or of the concave surface of the shell 44, are coated with a thin friction coating, for example of a rubber-like material, in order to increase the friction at the tubes 12, 14, 16. If required, the intermediate element 36 can also be provided with such a friction coating on its surfaces resting against the tubes 12, 14.

The inside-located fastening arrangements in accordance with FIGS. 3 and 5 permit the construction of very light support frames, which can support large loads, in particular if using tubes made of CFR plastic. However, in comparison with conventional support frames which are to be equipped with vacuum grippers, they have the disadvantage that the connecting points between the tubes are determined by the bores. When using customary clamping elements enclosing the tubes at the outside, the frame construction is more variable and can be easily matched to changing conditions. It is therefore suggested in accordance with the invention to produce a basic frame with the help of particularly light tubes made of CFR plastic, and also of the particularly light, inside located fastening arrangements in accordance with FIGS. 3 and 5, to whose tubes further tubes for positioning the required vacuum grippers are then attached as the case may be by means of clamping elements or clamping blocks, which enclose the tubes on the outside.

It is understood that the connection principle represented in FIG. 5 can also be realized if the tube 17 is not a round tube, but a tube of rectangular or other cross section. It is possible to attach a counterpiece 38 in the tube 17 in the same way as in accordance with FIG. 5. This makes possible, for example, a construction as shown in FIG. 7. There, two side-by-side arranged rectangular tubes 17′ of identical length, at both of whose ends a counterpiece 38 is fastened by means of a glued-in tube element rectangular in cross section, are connected with two parallel tubes 16′ wherein, in the case of the example, two screws 22 are provided for each tube connection, because of the comparatively large width of the rectangular tubes 17′, which screws extend through one or two side-by-side arranged inserts 20 in the round tubes 16′ and are screwed into two side-by-side arranged threaded bores of the counterpieces 38 in the rectangular tubes 17′.

The rectangular tubes 17′ which, the same as the tubes 16′, are preferably made of CFR plastic, provide a large-surface contact area for two disks 46, 48 of aluminum or steel attached to oppositely located sides. The disks 46, 48 can be fixedly screwed together through holes in the rectangular tubes 17′ and can be flanged to a matching coupling plate of a robot arm, for example. In the example shown, the disk 46 is provided with a centering shoulder in the middle for centering.

The frame shown in FIG. 1 could also be made of octagonal tubes. In FIGS. 8 to 11 it is shown how the intersections of the tubes then look. The T-shaped connecting point is shown in FIGS. 12 to 15. It is possible to see in FIGS. 8 to 15, in which the details corresponding to particular details in FIGS. 1 to 6 are provided with reference numerals each raised by 100, that for all practical purposes all details agree, or can agree, analogously and functionally. The only difference lies in that it is necessary to match the inserts and intermediate elements, as well as in connection with the T-shaped connection the counterpiece and the chamfered-out part of the tube end, to the octagonal cross section of the tubes. As to the rest, reference can be made to the above description in connection with FIGS. 1 to 6. The only modification going farther than this ensues from the comparison of FIGS. 14 and 15 with FIGS. 5 and 6. In the embodiment in accordance with FIGS. 14 and 15, the counterpiece 138 is formed of one piece with the tube element 142 and moved so close to the end of the tube 117 that, in the assembled state, it rests against the exterior circumferential surface of the tube 116, so that a shell corresponding to the shell 44 can be omitted.

It is furthermore possible to see from FIGS. 8 to 15 that the bores 128 and assembly holes 130, 132 are each located in a flat partial surface of the octagonal tube wall. Although it would be possible to connect two octagonal tubes which cross each other at relative positions wherein a corner of at least one of the two tubes points toward the other tube, it would then be necessary to produce the holes and bores at a corner, something which in principle is possible as an alternative, but is somewhat more complicated.

1-21. (canceled)

22. A fastening arrangement for connecting round or octagonal tubes, which are conducted past each other in an intersecting manner, by means of at least one screw, in particular in connection with support frames equipped with vacuum grippers for transporting and holding sheet metal parts in the automobile industry, wherein at the joint an insert is arranged in each one of the two tubes, which matches their respective inner cross section and partially fills it, one of the inserts constitutes an underlay for the head of the screw extending through aligned transverse bores in the tubes, and whose other insert forms a support for the screw shank, and that an intermediate element matched to the outer circumferential surfaces of the two tubes is clamped between the two tubes.

23. The fastening arrangement in accordance with claim 22, wherein the insert constituting the support for the screw shank is provided with a cylindrical through-bore and has a support surface for a nut seated on the screw shank.

24. The fastening arrangement in accordance with claim 22, wherein the insert constituting the support for the screw shank is provided with a threaded bore matching the screw.

25. The fastening arrangement in accordance with claim 22, wherein at least one of the two inserts is glued into one of the tubes.

26. The fastening arrangement in accordance with claim 22, wherein the height of the inserts, measured in the longitudinal direction of the screw is at least 30%, preferably more than 90%, of half the interior transverse dimension of the respectively assigned tube.

27. The fastening arrangement in accordance with claim 22, wherein the intermediate element maintains the two tubes spaced apart and rests respectively over 90 to 180° against the circumference of the tubes.

28. The fastening arrangement in accordance with claim 22, wherein the wall of at least one of the tubes is reinforced by a glued-on or glued-in tube element in the area of the intersection.

29. The fastening arrangement in accordance with claim 22, wherein, aligned with the transverse bore through which the screw extends, at least one of the tubes has an assembly hole, which has a larger cross section, through which the screw is accessible.

30. A fastening arrangement for connecting tubes which adjoin in a T-shape, of which the first tube, which continues through the joint, is a round or octagonal tube, by means of at least one screw, in particular in connection with support frames equipped with vacuum grippers for transporting and holding sheet metal parts in the automobile industry, wherein an insert is arranged in the first tube, which matches its interior cross section and partially fills it and forms an underlay for the head of the screw extending through a transverse bore in the first tube, whose shank can be screwed into a counterpiece fixed in place in the second tube terminating at the joint, wherein the adjoining end of the second tube is chamfered out to match the circumferential surface of the first tube.

31. The fastening arrangement in accordance with claim 30, wherein the end of the second tube has been chamfered out to such a depth that the pressing force generated between the tubes by tightening the screw acts on the entire circumference of the end edge of the second tube, or that the end substantially extends around half the circumference of the first tube.

32. The fastening arrangement in accordance with claim 30, wherein the counterpiece consists of a disk having an axial threaded bore matching the screw, preferably made of steel, which is inserted behind a tube element glued into the end area of the second tube, or is formed as one piece with the tube element.

33. The fastening arrangement in accordance with claim 30, wherein, aligned with the transverse bore, the first tube has an assembly hole, which has a larger cross section, through which the screw is accessible.

34. The fastening arrangement in accordance with claim 30, wherein the height of the insert, measured in the longitudinal direction of the screw is at least 30%, preferably more than 90%, of half the interior transverse dimension of the first tube.

35. The fastening arrangement in accordance with claim 30, wherein the wall of the first tube is reinforced by a glued-on or glued-in tube element in the area of the intersection.

36. The fastening arrangement in accordance with claim 30, wherein a shell, substantially comprising a tube section, is clamped between the circumferential surface of the first tube and the matching chamfered-out end of the second tube.

37. The fastening arrangement in accordance with claim 30, wherein the second tube is a round tube, or a tube which in cross section is octagonal or rectangular.

38. The fastening arrangement in accordance with claim 30, wherein the insert in at least one of the tubes consists of an aluminum alloy or a strong plastic material.

39. The fastening arrangement in accordance with claim 30, wherein the tubes and/or tube elements are made of CFR plastic material.

40. A tubular frame, comprising at least two continuous tubes and at least two tubes adjoining the continuous tubes in a T-shape, wherein the tubes are connected at the intersections or joints by means of a fastening arrangement in accordance with claim 30.

41. The tubular frame in accordance with claim 40, wherein two tubes, which are rectangular in cross section and adjoin the continuous round or octagonal tubes in a T-shape, are arranged side-by-side and are clamped between two disks or plates, which are connected with each other by screws and have assembly bores and/or fastening elements for being connected to a component supporting the tubular frame.

42. The tubular frame in accordance with claim 40, wherein it supports further tube-shaped frame elements, which are clamped to the tubes being connected by the fastening arrangements in accordance with claim 9 by means of clamping elements enclosing the exterior of the tubes.

43. The fastening arrangement in accordance with claim 22, wherein the insert in at least one of the tubes consists of an aluminum alloy or a strong plastic material.

44. The fastening arrangement in accordance with claim 22, wherein the tubes and/or tube elements are made of CFR plastic material.

45. A tubular frame, comprising at least two continuous tubes and at least two tubes conducted past the former ones in an intersecting manner, wherein the tubes are connected at the intersections or joints by means of a fastening arrangement in accordance with claim 22.

46. A tube frame comprising at least two continuous tubes and at least two tubes conducted past the former ones in an intersecting manner, and wherein the frame supports further tube-shaped frame elements which are clamped to the tubes being connected by the fastening arrangements in accordance with claim 22 by means of clamping elements enclosing the exterior of the tubes.
